(19) United States
(12) Patent Application Publication
(10) Pub. No.: US 2026/0163277 A1
(43) Pub. Date: Jun. 11, 2026

(54) PLUG STRUCTURE

(71) Applicant: LITE-ON Technology Corporation, Taipei (TW)

(72) Inventors: Yung-Hsien WU, Taipei (TW); Chia-Tsang HSU, Taipei (TW); Ying-Hsien CHEN, Taipei (TW)

(21) Appl. No.: 19/198,151

(22) Filed: May 5, 2025

(30) Foreign Application Priority Data
Dec. 11, 2024 (CN) 2024118152642

(51) Int. Cl. H01R 13/04; H01R 13/03; H01R 24/28

(52) U.S. Cl. CPC H01R 13/04; H01R 13/03; H01R 24/28

(57) ABSTRACT

Disclosed is a plug structure including a plug body and a pin. The pin has a first plastic piece and a second plastic piece, the first plastic piece is disposed on the plug body, the first plastic piece has a fixing portion, and the second plastic piece covers the first plastic piece, wherein the second plastic piece and the fixing portion are fixed to each other. The pin is made of two plastic materials, which can reduce costs and improve the structural strength of the pin.

### CROSS REFERENCE TO RELATED PRESENT DISCLOSURE

This application claims the priority benefit of Chinese Patent Application Serial Number 2024118152642, filed on Dec. 11, 2024, the entire content of which is hereby incorporated by reference herein.

### TECHNICAL FIELD

The present disclosure relates to the technical field of electrical plugs, and in particular to a plug structure.

### RELATED ART

As for the structures of a plug and a socket, pins of the plug are inserted into insertion holes of the socket for use. The insertion holes of the socket comprise an insertion hole for neutral wire, an insertion hole for live wire and an insertion hole for ground wire. Taking the plug and the socket of UK (United Kingdom) standard as an example, when the socket is not in use, the insertion holes for non-ground wire will be closed; when the plug is plugged into the socket, the pin is inserted into the insertion hole for ground wire to release the shield restriction of the insertion holes for non-ground wire, so that the pins can also be inserted into the insertion holes for non-ground wires for use. However, the existing pin for inserting into the insertion hole for ground wire is made of metal, which has the problem of high cost, and the pin made of plastic has the problem that the structural strength of the pin is not high.

### SUMMARY

The embodiments of the present disclosure provide a plug structure, which can solve the problems of high cost and insufficient structural strength of the pin by using a pin made of two plastic pieces.

In order to solve the above technical problems, the present disclosure is implemented as follows.

The present disclosure provides a plug structure including a plug body and a pin. The pin has a first plastic piece and a second plastic piece, the first plastic piece is disposed on the plug body, the first plastic piece has a fixing portion, and the second plastic piece covers the first plastic piece, wherein the second plastic piece and the fixing portion are fixed to each other.

In one embodiment, the first plastic piece and the second plastic piece are made of different plastic materials.

In one embodiment, a material combination for the first plastic piece and the second plastic piece is a material combination of nylon and polycarbonate, a material combination of polycarbonate and a mixture of acrylonitrile butadiene styrene and polycarbonate, or a material combination of acrylonitrile butadiene styrene and a mixture of acrylonitrile butadiene styrene and polycarbonate.

In one embodiment, the fixing portion of the first plastic piece comprises a plurality of notches, and the plurality of notches are arranged at intervals on at least one surface of the first plastic piece.

In one embodiment, each notch has a bottom surface, a first side wall and a second side wall, the first side wall and the second side wall are disposed on two sides of the bottom surface, and the first side wall and the second side wall are perpendicular to the bottom surface.

In one embodiment, each notch has an arc bottom surface.

In one embodiment, each notch has a first inclined surface and a second inclined surface, and a bottom edge of the first inclined surface and a bottom edge of the second inclined surface are connected to each other.

In one embodiment, the first plastic piece has a first surface and a second surface opposite to the first surface, the plurality of notches are respectively disposed on the first surface and the second surface, and the plurality of notches on the first surface and the plurality of notches on the second surface correspond to each other.

In one embodiment, the first plastic piece has a first surface and a second surface opposite to the first surface, the plurality of notches are respectively disposed on the first surface and the second surface, and the plurality of notches on the first surface and the plurality of notches on the second surface are mutually staggered.

In one embodiment, the fixing portion of the first plastic piece comprises a plurality of through holes, and the plurality of through holes are arranged at intervals on a surface of the first plastic piece.

The present disclosure provides a plug structure including a plug body and a pin, wherein the pin uses a first plastic piece as an internal support structure, and uses a second plastic piece to cover the first plastic piece, so that the structural strength of the pin can be further enhanced. The present disclosure uses the first plastic piece to replace a metal piece as the internal support structure to reduce costs. At the same time, the combination of the two plastic materials can also improve the overall structural strength of the pin.

### BRIEF DESCRIPTION OF THE DRAWINGS

The accompanying drawings described herein are used to provide further understanding for the present disclosure, and constitute a part of the present disclosure. The exemplary embodiments of the present disclosure and their descriptions are used to explain the present disclosure, and do not constitute an improper limitation of the present disclosure. In the accompanying drawings:

FIG. 1 is a stereoscopic view of a plug structure of the present disclosure;

FIG. 2 is an exploded view of a plug structure of the present disclosure;

FIG. 3 is a cross-sectional view of a first embodiment taken along line A-A′ in FIG. 1;

FIG. 4 is a cross-sectional view of a second embodiment taken along line A-A′ in FIG. 1;

FIG. 5 is a cross-sectional view of a third embodiment taken along line A-A′ in FIG. 1;

FIG. 6 is a cross-sectional view of a fourth embodiment taken along line A-A′ in FIG. 1;

FIG. 7 is a cross-sectional view of a fifth embodiment taken along line A-A′ in FIG. 1; and

FIG. 8 is a cross-sectional view of a sixth embodiment taken along line A-A′ in FIG. 1.

### DETAILED DESCRIPTION OF THE EMBODIMENTS

The following will disclose multiple embodiments of the present disclosure with drawings, and for clarity, many practical details will be described together in the following description. However, it should be understood that these practical details should not be used to limit the present disclosure. That is, in some embodiments of the present disclosure, these practical details are unnecessary. In addition, for simplifying the drawings, some well-known and commonly used structures and elements will be shown in a simple and schematic manner in the drawings. In the following embodiments, the same reference numerals are used to indicate the same or similar components.

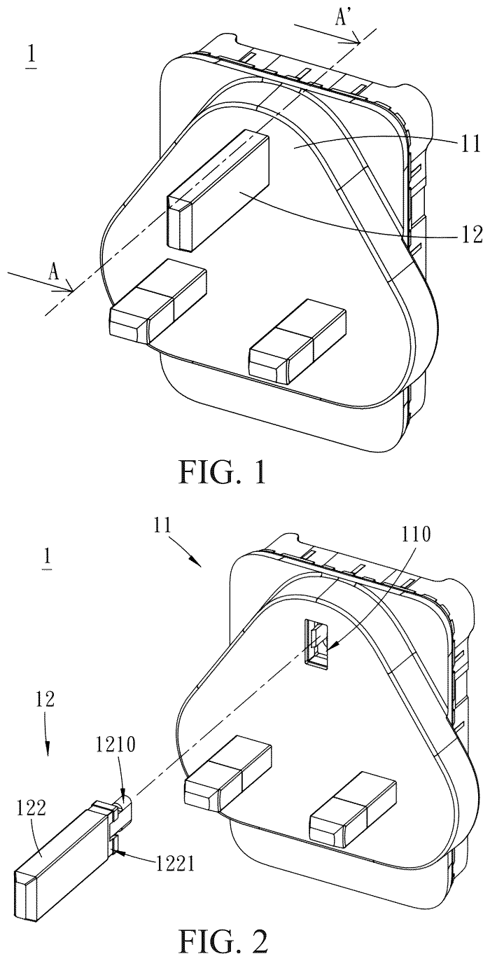

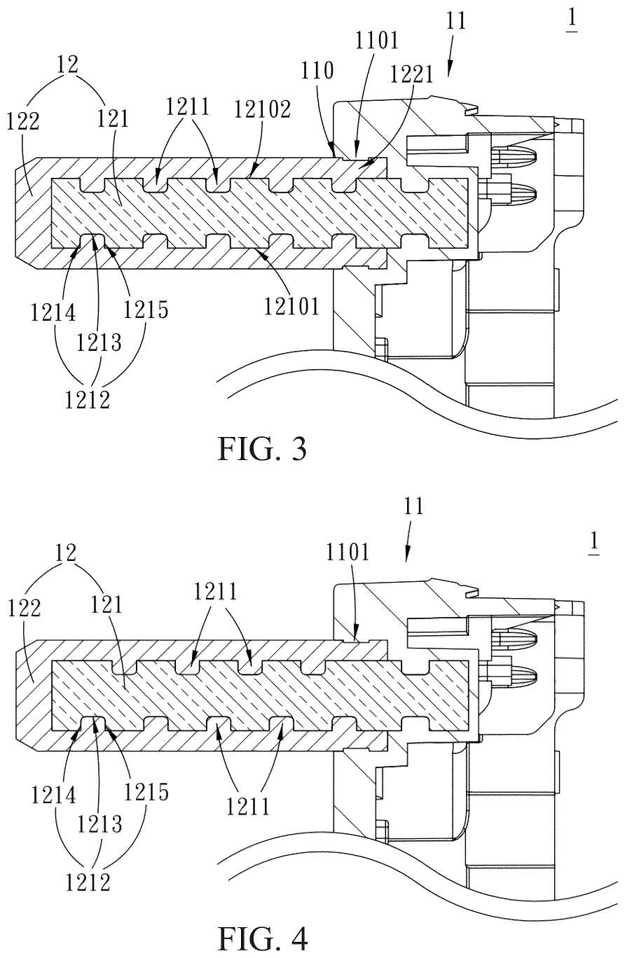

Please refer to FIG. 1 to FIG. 3, wherein FIG. 1 is a stereoscopic view of a plug structure of the present disclosure, FIG. 2 is an exploded view of a plug structure of the present disclosure, and FIG. 3 is a cross-sectional view of a first embodiment taken along line A-A′ in FIG. 1. As shown in the figures, the present disclosure provides a plug structure 1, which comprises a plug body 11 and a pin 12. The pin 12 has a first plastic piece 121 and a second plastic piece 122. The first plastic piece 121 is disposed on the plug body 11. The first plastic piece 121 has a fixing portion 1211. The second plastic piece 122 covers the first plastic piece 121, wherein the second plastic piece 122 and the fixing portion 1211 are fixed to each other. In other words, the second plastic piece 122 and the fixing portion 1211 together form an assembly and are fixed to each other. In the drawings of the present disclosure, the structure of the long pin of the British plug structure is used as an example for explanation, but the present disclosure is not limited to the long pin of the British plug structure.

In this embodiment, the first plastic piece 121 and the second plastic piece 122 of the pin 12 are made of different plastic materials by injection molding. Among them, the first plastic piece 121 is used as a structure connected to the plug body 11, the first plastic piece 121 needs to have a higher bearing capacity to maintain the non-breaking characteristic of the pin 12, and the first plastic piece 121 has higher toughness than the second plastic piece 122. In addition, the second plastic piece 122 serves as a covering structure for the outer side of the pin 12, the second plastic piece 122 needs to be a contact surface to prevent external impact, and the second plastic piece 122 has a higher impact resistance than the first plastic piece 121. At the same time, the socket may have a high internal temperature if it is used for a long time, so the outer surface of the pin 12 also needs to be resistant to high temperatures and flame retardant. In order to prevent the pins 12 from being affected by high temperature, the second plastic piece 122 has higher high-temperature resistance and a higher flame retardancy than the first plastic piece 121.

As mentioned above, the first plastic piece 121 and the second plastic piece 122 can be made of different materials. A material combination for the first plastic piece 121 and the second plastic piece 122 is a material combination of nylon (PA) and polycarbonate (PC), a material combination of polycarbonate and a mixture of acrylonitrile butadiene styrene (ABS) and polycarbonate, or a material combination of a mixture of acrylonitrile butadiene styrene and a mixture of acrylonitrile butadiene styrene and polycarbonate. In addition, the combination of two plastic materials of the first plastic piece 121 and the second plastic piece 122 can also avoid using a single plastic structure that is too thick, which may cause a shrinkage problem. Furthermore, the plastic material of the second plastic piece 122 and the material of the plug body 11 can be the same material, so that the appearance of the plug body 11 and the pin 12 of the plug structure 1 can be consistent.

Moreover, the first plastic piece 121 is a rectangular structure made by injection molding, the first plastic piece 121 has a plugging end 1210, the plug body 11 has a plugging port 110, and the plugging end 1210 of the first plastic piece 121 is used to be plugged and fixed to the plugging port 110 of the plug body 11. In this embodiment, the first plastic piece 121 has a fixing portion 1211, and the fixing portion 1211 is located on a side of the first plastic piece 121. The fixing portion 1211 comprises a plurality of notches 1212, the plurality of notches 1212 are arranged along an extension direction of the first plastic piece 121 away from the plugging end 1210, and the plurality of notches 1212 are arranged at intervals on at least one surface of the first plastic piece 121. Each notch 1212 has a bottom surface 1213, a first side wall 1214 and a second side wall 1215. The first side wall 1214 and the second side wall 1215 are disposed on two sides of the bottom surface 1213, and the first side wall 1214 and the second side wall 1215 are perpendicular to the bottom surface 1213, so as to form a sawtooth structure.

Further, the second plastic piece 122 is overmolded on the outer surface of the first plastic piece 121, but the second plastic piece 122 does not cover the plugging end 1210 of the first plastic piece 121. That is, the plugging end 1210 of the first plastic piece 121 covered by the second plastic piece 122 is exposed. The second plastic piece 122 can cover the surface of the fixing portion 1211. In other words, the partial structure of the second plastic piece 122 can fill the plurality of notches 1212 of the first plastic piece 121. In this way, the second plastic piece 122 can be stably disposed on the outer surface of the first plastic piece 121, and the bonding strength of the second plastic piece 122 relative to the plurality of notches 1212 of the first plastic piece 121 can prevent the second plastic piece 122 from detaching from the surface of the first plastic piece 121 in a direction away from the plugging end 1210.

Furthermore, the second plastic piece 122 has a first connection portion 1221 on one side thereof close to the plugging end 1210 of the first plastic piece 121, and the plugging port 110 of the plug body 11 has a second connection portion 1101. When the plugging end 1210 of the first plastic piece 121 is inserted into the plugging port 110, the first connection portion 1221 of the second plastic piece 122 is connected and fixed to the second connection portion 1101 in the plugging port 110, and the second plastic piece 122 is embedded in the plugging port 110. In other words, the second plastic piece 122 and the surface of the plug body 11 form an integrated structure. The first connection portion 1221 and the second connection portion 1101 may be concave-convex structures that are mutually fastened.

In addition, the first plastic piece 121 has a first surface 12101 and a second surface 12102 opposite to the first surface 12101, the plurality of notches 1212 can be respectively disposed on the first surface 12101 and the second surface 12102, and the plurality of notches 1212 on the first surface 12101 and the plurality of notches 1212 on the second surface 12102 correspond to each other.

Please refer to FIG. 3 to FIG. 4, wherein FIG. 4 is a cross-sectional view of a second embodiment taken along line A-A′ in FIG. 1. As shown in FIG. 4, in this embodiment, the first plastic piece 121 has a first surface 12101 and a second surface 12102 opposite to the first surface 12101, the plurality of notches 1212 can be respectively disposed on the first surface 12101 and the second surface 12102, and the plurality of notches 1212 on the first surface 12101 and the plurality of notches 1212 on the second surface 12102 are mutually staggered.

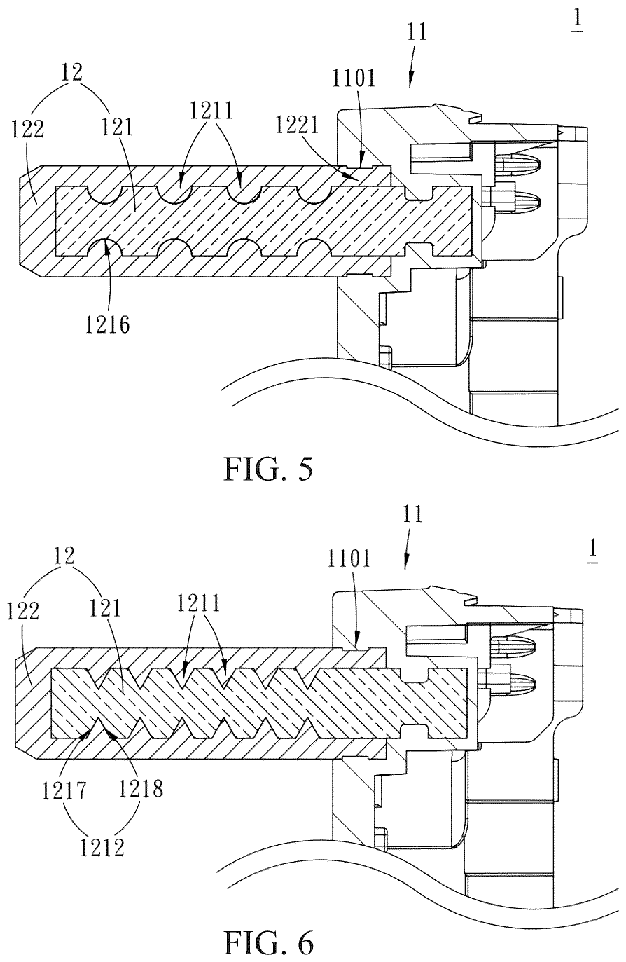

Please refer to FIG. 5, which is a cross-sectional view of a third embodiment taken along line A-A′ in FIG. 1. As shown in the figure, the difference between this embodiment and the first embodiment is that the structures of the notches 1212 are different. In this embodiment, each notch 1212 has an arc bottom surface 1216. In other words, the second plastic piece 122 is overmolded on the surface of the fixing portion 1211, so that the partial structure of the second plastic piece 122 can fill the arc bottom surface 1216 of the plurality of notches 1212 of the first plastic piece 121.

Please refer to FIG. 6, which is a cross-sectional view of a fourth embodiment taken along line A-A′ in FIG. 1. As shown in the figure, the difference between this embodiment and the first embodiment is that the structures of the notches 1212 are different. In this embodiment, each notch 1212 has a first inclined surface 1217 and a second inclined surface 1218, and a bottom edge of the first inclined surface 1217 and a bottom edge of the second inclined surface 1218 are connected to each other, so as to form a tine structure. In other words, the second plastic piece 122 is overmolded on the surface of the fixing portion 1211, so that the partial structure of the second plastic piece 122 can fill the tines of the plurality of notches 1212 of the first plastic piece 121. The tines may be slender pointed notches.

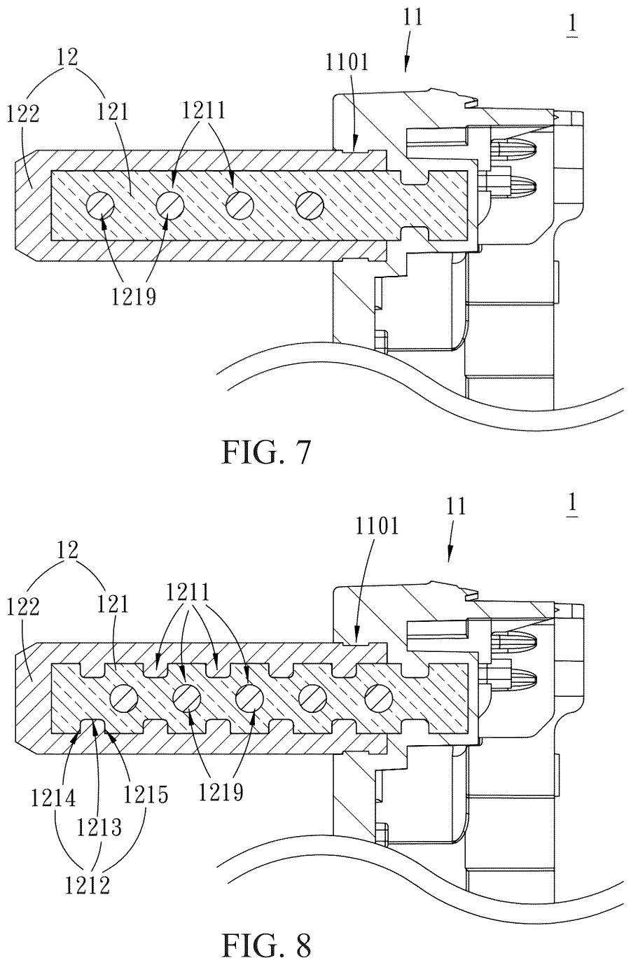

Please refer to FIG. 7, which is a cross-sectional view of a fifth embodiment taken along line A-A′ in FIG. 1. As shown in the figure, the difference between this embodiment and the first embodiment is that the structures of the fixing portions 1211 are different. In this embodiment, the fixing portion 1211 of the first plastic piece 121 comprises a plurality of through holes 1219, and the plurality of through holes 1219 are arranged at intervals on a surface of the first plastic piece 121. The plurality of through holes 1219 penetrates the first plastic piece 121, and the second plastic piece 122 is overmolded on the surface of the fixing portion 1211, so that the partial structure of the second plastic piece 122 can fill the plurality of through holes 1219 of the first plastic piece 121. In addition, the through hole 1219 can also be replaced by a hole on the first plastic piece 121, which can also achieve the same fixing effect as in the present disclosure.

Please refer to FIG. 8, which is a cross-sectional view of a sixth embodiment taken along line A-A′ in FIG. 1. As shown in the figure, the difference between this embodiment and the first embodiment is that the structures of the fixing portions 1211 are different. In this embodiment, the fixing portion 1211 of the first plastic piece 121 comprises a combination of a plurality of notches 1212 and a plurality of through holes 1219, wherein the interior of the second plastic piece 122 can simultaneously fill the plurality of notches 1212 and the plurality of through holes 1219, thereby enhancing the structural strength of the second plastic piece 122 fixed to the first plastic piece 121. The above embodiment is a structural combination of the first embodiment and the fifth embodiment. The first embodiment to the fifth embodiment of the present disclosure can use one or more structural combinations to fix the second plastic piece 122 to the first plastic piece 121.

In each embodiment of the present disclosure, the fixing portion 1211 is a non-planar structure on the side of the first plastic piece 121. That is, the side surface of the first plastic piece 121 is processed by cutting grooves or digging holes to form the non-planar structure. The second plastic piece 122 is directly overmolded on the surface of the first plastic piece 121 with the fixing portion 1211, and the internal structure of the second plastic piece 122 can fill the non-planar structure of the fixing portion 1211, so that the inner surface of the second plastic piece 122 and the side of the first plastic piece 121 form an assembled fixed structure to prevent the second plastic piece 122 from detaching from the first plastic piece 121.

In summary, the present disclosure provides a plug structure including a plug body and a pin, wherein the pin has a first plastic piece as an internal support structure, and has a second plastic piece which covers the first plastic piece, so that the structural strength of the pin can be further enhanced. The present disclosure uses the first plastic piece to replace a metal piece as the internal support structure to reduce costs. At the same time, the combination of the two plastic materials can also improve the overall structural strength of the pin.

The above description shows and describes several preferred embodiments of the present disclosure. However, as mentioned above, it should be understood that the present disclosure is not limited to the form disclosed herein, and should not be regarded as excluding other embodiments, while embodiments of the present disclosure can be used in various other combinations, modifications and environments, and can be changed through the above teachings or technologies or knowledge in the related field within the scope of the concept of the present disclosure described herein. The modifications and changes made by those in the art without departing from the spirit and scope of embodiments of the present disclosure should fall within the protection scope of the claims attached to embodiments of the present disclosure.

What is claimed is:

1. A plug structure, comprising:
a plug body; and
a pin having a first plastic piece and a second plastic piece, the first plastic piece being disposed on the plug body, the first plastic piece having a fixing portion, and the second plastic piece covering the first plastic piece, wherein the second plastic piece and the fixing portion are fixed to each other.

2. The plug structure according to claim 1, wherein the first plastic piece and the second plastic piece are made of different plastic materials.

3. The plug structure according to claim 2, wherein a material combination for the first plastic piece and the second plastic piece is a material combination of nylon and polycarbonate, a material combination of polycarbonate and a mixture of acrylonitrile butadiene styrene and polycarbonate, or a material combination of acrylonitrile butadiene styrene and a mixture of acrylonitrile butadiene styrene and polycarbonate.

4. The plug structure according to claim 1, wherein the fixing portion of the first plastic piece comprises a plurality of notches, and the plurality of notches are arranged at intervals on at least one surface of the first plastic piece.

5. The plug structure according to claim 4, wherein each notch has a bottom surface, a first side wall and a second side wall, the first side wall and the second side wall are disposed on two sides of the bottom surface, and the first side wall and the second side wall are perpendicular to the bottom surface.

6. The plug structure according to claim 4, wherein each notch has an arc bottom surface.

7. The plug structure according to claim 4, wherein each notch has a first inclined surface and a second inclined surface, and a bottom edge of the first inclined surface and a bottom edge of the second inclined surface are connected to each other.

8. The plug structure according to claim 4, wherein the first plastic piece has a first surface and a second surface opposite to the first surface, the plurality of notches are respectively disposed on the first surface and the second surface, and the plurality of notches on the first surface and the plurality of notches on the second surface correspond to each other.

9. The plug structure according to claim 4, wherein the first plastic piece has a first surface and a second surface opposite to the first surface, the plurality of notches are respectively disposed on the first surface and the second surface, and the plurality of notches on the first surface and the plurality of notches on the second surface are mutually staggered.

10. The plug structure according to claim 1, wherein the fixing portion of the first plastic piece comprises a plurality of through holes, and the plurality of through holes are arranged at intervals on a surface of the first plastic piece.
